(19) United States
(12) Patent Application Publication
(10) Pub. No.: US 2018/0326370 A1
(43) Pub. Date: Nov. 15, 2018

(54) METHOD AND DEVICE FOR PRODUCING EMULSIONS

(71) Applicants: CENTRE NATIONAL DE LA RECHERCHE SCIENTIFIQUE-CNRS, PARIS (FR); INSERM (Institut National de la Santé et de la Recherche Médicale), PARIS (FR); Ecole Supérieure de Physique et de Chimie Industrielles de la Ville de Paris, PARIS (FR)

(72) Inventors: Olivier COUTURE, ISSY LES MOULINEAUX (FR); Mickael TANTER, BAGNEUX (FR); Claudia ERRICO, PARIS (FR)

(21) Appl. No.: 15/774,253

(22) PCT Filed: Nov. 8, 2016
(86) PCT No.: PCT/FR2016/052890

§ 371 Date: May 7, 2018

(30) Foreign Application Priority Data
Nov. 18, 2015 (FR) 15 61082

(51) Int. Cl. B01F 3/08; B01F 13/00; B01F 5/04

(52) U.S. Cl. CPC B01F 3/0807; B01F 2003/0834; B01F 5/0475; B01F 13/0071

(57) ABSTRACT

A method for manufacturing an emulsion comprises drops in an external solution, the drops containing a fluid. The fluid is moved along a first main channel, a portion of the fluid moving in the first main channel is withdrawn via a plurality of microchannels positioned in parallel between the first main channel and a second main channel filled with external solution, the drops are formed by hydrodynamic focusing when the fluid passes from each microchannel into the second main channel.

### FIELD OF THE INVENTION

The present invention relates to methods and devices for the manufacture of emulsions.

### BACKGROUND OF THE INVENTION

Emulsions, for example micro- or nanoemulsions, are widely used, in particular in medical applications. By way of example, use is made of emulsions which can be activated by ultrasound, which emulsions are intended to transport, for example, a medicament or a marker into the human body in order to locally activate it in a target region. The document WO2011007082A1 gives an example of such an emulsion which is particularly effective.

Unfortunately, the methods for the manufacture of emulsions used to date are not entirely satisfactory. The methods used are generally slow, for example when a single microchannel operating by hydrodynamic focusing is used.

Attempts have been made to enhance production (see, for example, Cohen et al., “Parallelised production of fine and calibrated emulsions by coupling flow-focusing technique and partial wetting phenomenon”, Microfluidics and Nanofluidics, 17, No. 5 (2014), 959-966), but these attempts have resulted in microfluidic devices which are not very reliable and which are subject to blocking.

The documents WO2006/039568 and EP 1 197 262 A2 present microfluidic devices which are subject to the same difficulties.

### SUBJECT MATTERS AND SUMMARY OF THE INVENTION

It is thus a subject matter of the present invention to provide a method for the manufacture of emulsions which both makes it possible to produce larger amounts of emulsion and is reliable.

To this end, the invention provides a microfluidic method for the manufacture of an emulsion comprising drops in emulsion in an external solution, the drops containing a fluid, in which method:

the fluid is moved along a first main channel,

a portion of the fluid moving in the first main channel is withdrawn, via a plurality of microchannels positioned along the first main channel, which each communicate individually with said first main channel and each emerge individually in a space filled with external solution, the first main channel being maintained at a greater pressure than said space filled with external solution, the first main channel having a passage cross-section at least 5 times greater than each microchannel,

the drops are formed when the fluid passes from each microchannel into said space filled with external solution,

in which method the fluid is moved along the first main channel between a first tank and a second tank which are maintained under excess pressure respectively at a first pressure and at a second pressure different from the first pressure, the first and second pressures being greater than atmospheric pressure, and the fluid is moved alternately in opposite directions along the first main channel, the first and second pressures being varied so that the first pressure is alternately greater and lower than the second pressure.

By virtue of these arrangements, the first main channel constitutes a stream in the microfluidic sense, which continuously cleans the mouths of the microchannels in the first main channel, thus preventing the blocking of the microchannels by possible debris or the like.

In various embodiments of the method according to the invention, it is optionally possible to additionally resort to one and/or other of the following arrangements:

said space filled with external solution is a second main channel and the external solution is moved along said second main channel, the second main channel having a passage cross-section at least 5 times greater than each microchannel: this arrangement also makes it possible to continuously clean the outlets of the microchannels in the second main channel;

the external solution is moved along the second main channel between a third tank and a fourth tank which are maintained under excess pressure respectively at a third pressure and at a fourth pressure different from the third pressure, the third and fourth pressures being greater than atmospheric pressure, and the external solution is moved alternately in opposite directions along the second main channel, the third and fourth pressures being varied so that the third pressure is alternately greater and lower than the fourth pressure: this arrangement makes it possible to guarantee the absence of contamination of the emulsion produced, since it is manufactured under excess pressure without opening the third and fourth tanks;

the drops have a diameter of less than 20 μm and the fluid contains nanodrops having a diameter of less than 5 μm;

the external solution contains a surface-active agent.

Furthermore, another subject matter of the invention is a microfluidic device for the manufacture of an emulsion comprising drops in emulsion in an external solution, the drops containing a fluid,

the device comprising:
a first main channel filled with fluid and connecting together a first tank and a second tank,
means for causing the fluid to move along the first main channel,
a space filled with external solution,
a plurality of microchannels positioned along the first main channel, which each communicate individually with said first main channel and each emerge individually in said space filled with external solution (2), said microchannels being adjusted in order to form the drops in the space filled with external solution, the first main channel having a passage cross-section at least 5 times greater than each microchannel,
pressurizing means for maintaining the first main channel at a greater pressure than said space filled with external solution,
the pressurizing means being adjusted in order to maintain the first tank and the second tank under excess pressure respectively at a first pressure and at a second pressure different from the first pressure, the first and second pressures being greater than atmospheric pressure, and the pressurizing means being provided in order to move the fluid alternately in opposite directions along the first main channel, the first and second pressures being varied so that the first pressure is alternately greater and lower than the second pressure.

In various embodiments of the microfluidic device according to the invention, it is optionally possible to additionally resort to one and/or other of the following arrangements:

said space filled with external solution is a second main channel and the microfluidic device comprises means for moving the external solution along said second main channel, the second main channel having a passage cross-section at least 10 times greater than each microchannel;

the second main channel connects together a third tank and a fourth tank and the microfluidic device comprises pressurizing means for maintaining the third tank and the fourth tank under excess pressure respectively at a third pressure and at a fourth pressure different from the third pressure, the third and fourth pressures being greater than atmospheric pressure, and the pressurizing means are provided in order to move the external solution alternately in opposite directions along the second main channel, the third and fourth pressures being varied so that the third pressure is alternately greater and lower than the fourth pressure.

### BRIEF DESCRIPTION OF THE DRAWINGS

Other characteristics and advantages of the invention will become apparent during the following description of one of its embodiments, given as nonlimiting example, taking into account the appended drawings.

In the drawings:

FIG. 1 is a diagrammatic view of a microparticle in emulsion in an aqueous solution, which can be obtained by a method according to an embodiment of the invention,

FIG. 2 is a schematic diagram of an example of microfluidic device according to an embodiment of the invention,

FIG. 3 is a detailed view of FIG. 2, and

FIG. 4 shows nanoparticles in emulsion in the starting fluid used in the device of FIGS. 2 and 3.

### MORE DETAILED DESCRIPTION

In the different figures, the same references denote identical or similar elements.

The present invention provides a method and a device for producing emulsions.

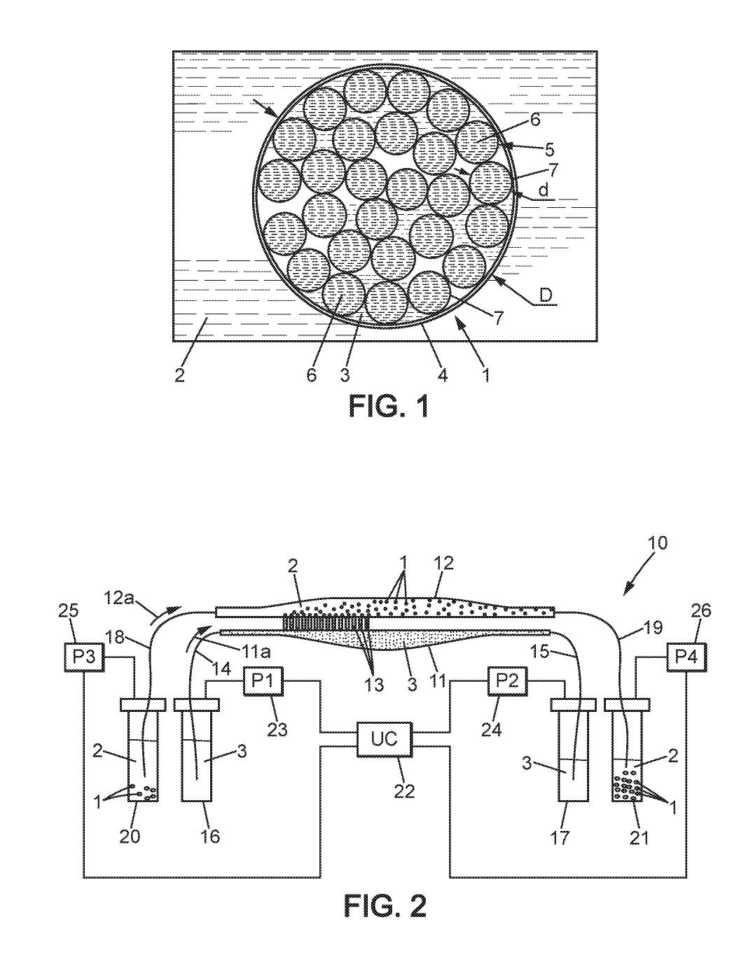

By way of example, the method and the device of the invention are particularly suitable for producing double emulsions, such as that represented diagrammatically in FIG. 1, but the method and the device of the invention can also be used to manufacture other types of emulsions, in particular simple emulsions.

As represented diagrammatically in FIG. 1, this double emulsion, which is described in more detail in the document WO2011007082A1, contains a secondary emulsion of microdrops 1 in an aqueous solution 2, these microparticles 1 having a diameter D of less than 20 μm. Just one of the microparticles 1 is represented in FIG. 1 in the interest of simplicity.

The microdrops 1 comprise a substantially spherical external wall 4 produced by a first emulsifier, in particular a surfactant, such as, for example, Pluronic F68®.

This external wall 4 encapsulates a gas-precursor liquid 3 which can be vaporized by ultrasound (or more generally a compound which can be activated by ultrasound) containing a primary emulsion of nanodrops 5 having a diameter of less than 5 μm, preferably from 0.3 to 1 μm. The gas precursor can be a fluorinated oil, in particular a perfluorocarbon, for example perfluorohexane or perfluoropentane.

These nanoparticles 5 each exhibit a substantially spherical external wall 7 which is formed by a second emulsifier, for example a fluorinated surfactant, such as poly(perfluoropropylene glycol) carboxylate (sold by Du Pont under the brand Krytox 157 FSH®).

The external wall 7 encapsulates an internal liquid 6, for example water or more generally an aqueous solution, which contains an active agent, in particular a label or a medicament.

More specifically, the active agent can be:

a label chosen in particular from optical dyes (for example fluorescein) and contrast agents for medical imaging (in particular contrast agents for MRI, X-rays, ultrasound or others);

a label intended to act as target for a therapeutic agent;

a therapeutic agent chosen in particular from cancer chemotherapy agents, antivascular medicaments, toxins and messenger RNA, DNA, and the like.

This double emulsion can be manufactured using the microfluidic device 10 of FIGS. 2 to 4, which can also be used to produce other types of emulsions, in particular any emulsion comprising drops 1 in emulsion in an external solution 2, the drops containing a fluid 3 (liquid or gas).

The microfluidic device 10 comprises:

a first main channel 11 (also called “stream” in microfluidic language) full of fluid 3,

means 22-24 for causing the fluid 3 to move along the first main channel 11 by creating differences in pressure,

a space 12 filled with external solution 2,

a plurality of microchannels 13 positioned along the first main channel 11, which each communicate individually with said first main channel 11 and each emerge individually in said space 12 filled with external solution 2,

pressurizing means 22-26 for maintaining the first main channel 11 at a greater pressure than said space 12 filled with external solution.

The first main channel 11 and the microchannels 13 can, for example, be etched in a sheet of glass, polydimethylsiloxane or other, covered with a closing sheet made of glass, polydimethylsiloxane or other.

The fluid 3 of the first main channel 11 is additivated with nanodrops 5 in the case where the abovementioned double emulsion is formed.

The external solution 2 can be additivated with surfactant, so that the fluid 3 forms drops 1 at the outlet of the microchannels, at its arrival in the space 12 filled with external solution.

The microchannels 13 have a much smaller cross-section than the first main channel 11, for example less than 20% of the cross-section of the first main channel 11. The microchannels generally have a width of less than 10 μm and a depth of less than 10 μm.

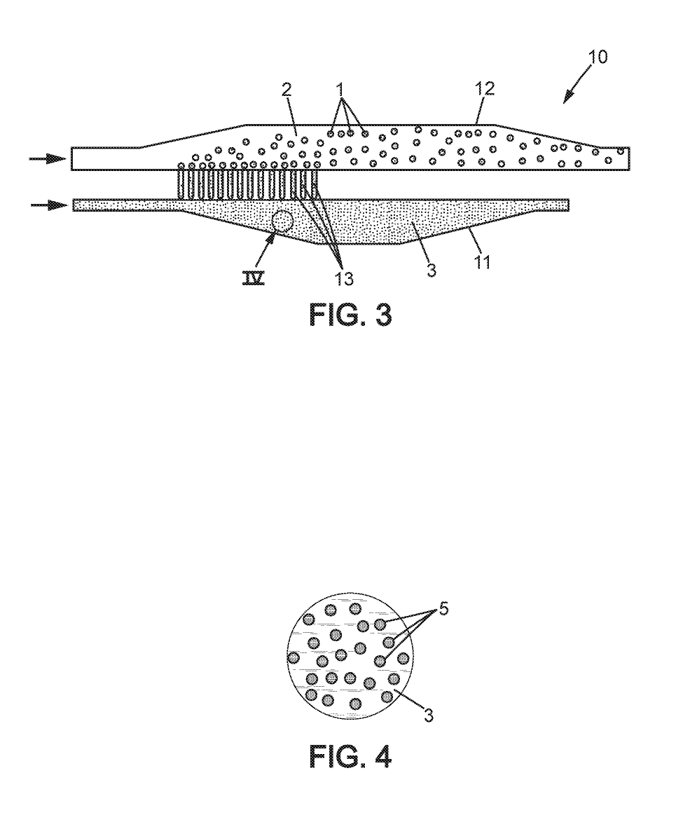

There are a great many microchannels 13, for example more than 100, indeed even several hundred (only a portion of these microchannels is represented in FIGS. 2 and 3).

By virtue of the movement of fluid in the first main channel 11, the blocking of the microchannels 13, in particular by nanodrops, is limited or prevented.

Advantageously, said space filled with external solution 2 can be a second main channel 12 (also called “stream” in microfluidic language) and the microfluidic device comprises means 22, 25, 26 for causing the external solution 2 to move along said second main channel 12, which also contributes to preventing the blocking of the microchannels 13.

The second main channel 12 can, for example, be etched in the abovementioned glass sheet, covered with a closing glass sheet.

The second main channel 12 can also have a passage cross-section at least 5 times greater than the cross-section of each microchannel 13.

Advantageously, the first main channel 11 connects together first and second closed tanks 16, 17 and the pressurizing means 22-26 are adjusted in order to maintain the first and second tanks 16, 17 under excess pressure, respectively at different first and second pressures P1, P2 greater than atmospheric pressure. The pressures in question are provided in order to cause the fluid 3 to move alternately in opposite directions along the first main channel 11, the first and second pressures being varied so that the first pressure P1 is alternately greater and lower than the second pressure P2.

Advantageously, the second main channel 12 can connect together third and fourth tanks 20, 21 and the microfluidic device comprises pressurizing means 22-26 for maintaining the third and fourth closed tanks 20, 21 under excess pressure, respectively at different third and fourth pressures P3, P4 which are greater than atmospheric pressure but lower than the abovementioned first and second pressures P1, P2, and the pressurizing means 22-26 are provided in order to move the external solution 2 alternately in opposite directions along the second main channel 12, the third and fourth pressures being varied so that the third pressure P3 is alternately greater and lower than the fourth pressure P4.

The abovementioned pressures in the tanks can be generated in particular by a multiroute pressure-generating system 22-26, for example of MFCS®-EZ type sold by Fluigent®. Such a system comprises several independent pressure sources 23-26, respectively connected to the tanks 16, 17, 20, 21 and respectively producing the pressures P1-P4. These pressure sources are controlled by a central unit 22, for example a computer or other.

The operation of the device is as follows.

At the beginning of the method for the manufacture of the emulsion, the first tank 16, for example, is filled with the fluid 3, for example containing the nanodrops 5, and the third tank 20, for example, is filled with the external solution 2 additivated with surfactant. The central unit 22 then controls the pressure sources 23-26 in order for P1>P2>P3>P4, so that the fluid 3 travels through the first main channel 11 in the direction of the arrow 11a (FIG. 2) and that the external solution 2 travels through the second main channel 12 in the direction of the arrow 12a. During this time, the second and fourth tanks 17, 21 gradually fill up, and a portion of the fluid 3 passes into the external solution 2 in the form of microdrops.

When the first tank 16 is empty, the pressures P1, P2 are modified in order for P2>P1, and the flow becomes established in the opposite direction to the arrow 11a. P1 and P2 remain greater than the pressure at every point in the second main channel 12.

Likewise, when the third tank 20 is empty, the pressures P3, P4 are modified in order for P4>P3, and the flow becomes established in the opposite direction to the arrow 12a. P3 and P4 remain lower than the pressure at every point in the first main channel 11.

While these alternating movements are taking place, all the fluid 3 initially present in the first tank 16 passes into the external solution 2, in the form of microdrops in emulsion, and this occurs rapidly and reliably, without risk of contaminating the emulsion produced with external impurities since the tanks are not opened throughout the method.

Optionally, the drops 1 can be denser than the external solution 2, in which case they accumulate in the bottom of the third and fourth tanks 20, 21.

1. A microfluidic method for manufacturing an emulsion comprising drops of emulsion in an external solution, the drops containing a fluid,
in which wherein the method:
the fluid is moved along a first main channel,
a portion of the fluid moving in the first main channel is withdrawn, via a plurality of microchannels positioned along the first main channel, which each communicate individually with said first main channel and each emerge individually in a space filled with external solution, the first main channel being maintained at a greater pressure than said space filled with external solution, the first main channel having a passage cross-section at least 5 times greater than each microchannel,
the drops are formed when the fluid passes from each microchannel into said space filled with external solution,
in which wherein method the fluid is moved along the first main channel between a first tank and a second tank which are maintained under excess pressure respectively at a first pressure and at a second pressure different from the first pressure, the first and second pressures being greater than atmospheric pressure, and the fluid is moved alternately in opposite directions along the first main channel, the first and second pressures being varied so that the first pressure is alternately greater and lower than the second pressure.

2. The microfluidic method as claimed in claim 1, wherein said space filled with external solution is a second main channel and the external solution is moved along said second main channel, the second main channel having a passage cross-section at least 5 times greater than each microchannel.

3. The microfluidic method as claimed in claim 2, wherein the external solution is moved along the second main channel between a third tank and a fourth tank which are maintained under excess pressure respectively at a third pressure and at a fourth pressure different from the third pressure, the third and fourth pressures being greater than atmospheric pressure, and the external solution is moved alternately in opposite directions along the second main channel, the third and fourth pressures being varied so that the third pressure is alternately greater and lower than the fourth pressure.

4. The microfluidic method as claimed in claim 1, wherein the drops have a diameter (D) of less than 20 μm and the fluid contains nanodrops having a diameter of less than 5 μm.

5. The microfluidic method as claimed in claim 1, wherein the external solution contains a surface-active agent.

6. A microfluidic device for manufacturing an emulsion comprising drops of emulsion in an external solution, the drops containing a fluid,
the device comprising:
a first main channel filled with fluid and connecting together a first tank and a second tank,
means for causing the fluid to move along the first main channel,
a space filled with external solution,
a plurality of microchannels positioned along the first main channel, which each communicate individually with said first main channel and each emerge individually in said space filled with external solution, said microchannels being adjusted in order to form the drops in the space filled with external solution, the first main channel having a passage cross-section at least 5 times greater than each microchannel,
pressurizing means for maintaining the first main channel at a greater pressure than said space filled with external solution, the pressurizing means being adjusted in order to maintain the first tank and the second tank under excess pressure respectively at a first pressure and at a second pressure different from the first pressure, the first and second pressures being greater than atmospheric pressure, and the pressurizing means being provided in order to move the fluid alternately in opposite directions along the first main channel, the first and second pressures being varied so that the first pressure is alternately greater and lower than the second pressure.

7. The microfluidic device as claimed in claim 6, wherein said space filled with external solution is a second main channel and the microfluidic device comprises means for moving the external solution along said second main channel, the second main channel having a passage cross-section at least 5 times greater than each microchannel.

8. The microfluidic device as claimed in claim 7, wherein the second main channel connects together a third tank and a fourth tank and the microfluidic device comprises pressurizing means for maintaining the third tank and the fourth tank under excess pressure respectively at a third pressure and at a fourth pressure different from the third pressure, the third and fourth pressures being greater than atmospheric pressure, and the pressurizing means are provided in order to move the external solution alternately in opposite directions along the second main channel, the third and fourth pressures being varied so that the third pressure is alternately greater and lower than the fourth pressure.
